(19) United States
(12) Patent Application Publication
(10) Pub. No.: US 2025/0245134 A1
(43) Pub. Date: Jul. 31, 2025

(54) Unified Connectivity Testing & Validtion System

(71) Applicant: Salesforce, Inc., San Francisco, CA (US)

(72) Inventors: Kaushal BANSAL, San Francisco, CA (US); Vijay BULUSU, San Francisco, CA (US); Armin BAHRAMSHAHRY, Vancouver (CA); Prabhat SINGH, San Francisco, CA (US)

(73) Assignee: Salesforce, Inc., San Francisco, CA (US)

(21) Appl. No.: 18/428,922

(22) Filed: Jan. 31, 2024

(51) Int. Cl. G06F 11/36

(52) U.S. Cl. CPC G06F 11/3688; G06F 11/3698

(57) ABSTRACT

A method for testing connectivity comprises receiving, by one or more computing devices, a request for a connectivity test, and determining, by the one or more computing devices, whether a point-to-point connectivity test or a service-to-service connectivity test is to be performed. The method further comprises initiating, by the one or more computing devices, the connectivity test in response to the request and based on the determining, where initiating the connectivity test comprises invoking a connectivity testing mechanism. The method further comprises displaying, by the one or more computing devices, a location of a connectivity issue based on the connectivity test, and displaying, by the one or more computing devices, a next step to solve the connectivity issue based on the connectivity test.

### BACKGROUND

The Internet and devices that use internet connections are becoming more prevalent in people's daily lives with the increasing popularity of smartphones and other smart devices. Software developers or computer programmers may need to monitor internet connectivity or availability of ongoing projects that need regular updates. For example, a software developer may log into a service developed and maintained by the developer to test the connectivity after updating the service. When a developer needs to test or monitor multiple services, this work could accumulate. Besides, the developer will need to decide which tools to use to test the connectivity. In another example, when a uniform resource locator (URL) stops working, hundreds of connections may need to be tested to find out the issue.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 shows an example environment for unified connectivity testing and validation, according to some aspects of this disclosure.

FIG. 2 shows an example testing component for unified connectivity testing and validation, according to some aspects of this disclosure.

FIG. 3 shows a flowchart of an example method for unified connectivity testing and validation, according to some aspects of this disclosure.

FIG. 4 shows a schematic block diagram of an example computer system in which aspects described may be implemented.

### DETAILED DESCRIPTION

Provided herein are system, apparatus, device, method, computer program product embodiments, and/or combinations and sub-combinations thereof, for unified connectivity testing and validation. An application or service, which can be used by customers, may work fine but suddenly cease to work. A service owner/developer who develops/builds the application or service may troubleshoot to determine if the service interruption is due to a connectivity issue. The service may also require connectivity to different components i.e. managed services offered by cloud providers, integration with another service, etc. The service owner may wish to define the service connectivity posture requirement using some metadata that includes details on the endpoints, types of tests, and/or frequency of tests.

In a different scenario, a control owner for network segmentation, ingress traffic, and/or another component of network infrastructure may define a connectivity posture for the logical boundary as a functional domain (FD) instance using metadata. This control owner may wish to monitor the connectivity posture and alert/notify in case of failures.

A control owner responsible for network segmentation and ingress traffic for infrastructure of a private network may have a continuous deployment model for rolling out changes for the network segmentation. The control owner may wish to run tests before and after any change to validate that the change is not going to impact the current availability of the overall infrastructure.

A build automation engineer may build out a new FD instance such as a new datacenter, with automation to build various foundations services, which are necessary for other services to onboard here. These foundation services may entail a specific set of connectivity. The build automation engineer may wish to define a set of connectivity tests, which execute after the build automation is complete and validate connectivity aspect of the new environment.

According to some aspects of this disclosure, a unified connectivity testing and validation system may impersonate different users and/or enable a user to perform unified connectivity testing and validation. The system may help achieve the goals of the abovementioned connectivity testing and validation for different control owners, service owners, engineers, and/or another user. This way, the user may utilize different mechanisms for performing connectivity testing and validation for services running across platforms without needing to specify details for connectivity tests.

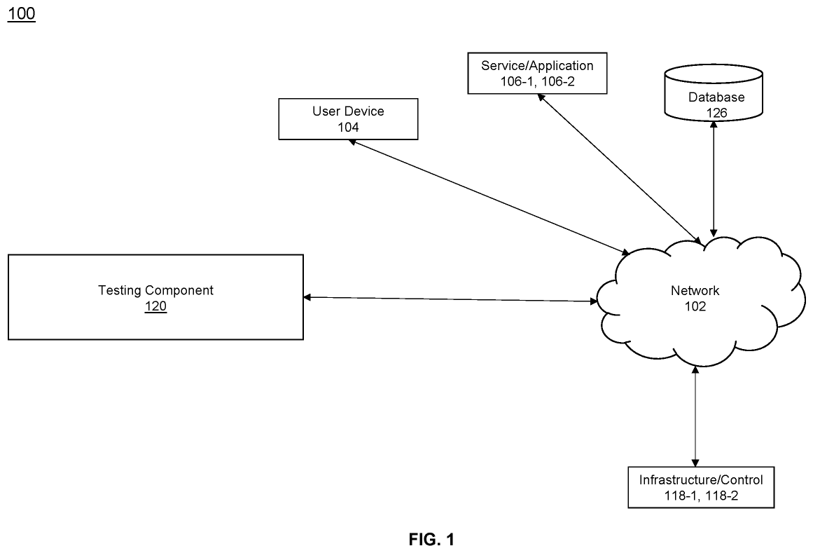

FIG. 1 shows an example environment 100 for unified connectivity testing and validation. Environment 100 is merely an example of one suitable system environment and is not intended to suggest any limitation as to the scope of use or functionality of aspects described herein. Neither should the environment 100 be interpreted as having any dependency or requirement related to any single module/component or combination of modules/components described therein.

Environment 100 may include a network 102. Network 102 may include a packet-switched network (e.g., internet protocol-based network), a non-packet-switched network (e.g., quadrature amplitude modulation-based network), and/or the like. Network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide area networks (e.g., Internet), local area networks, and/or the like. Network 102 may include a content access network, content distribution network, and/or the like. The Network 102 may provide and/or support communication from telephone, cellular, modem, and/or other electronic devices to and throughout the environment 100. For example, environment 100 may include a user device 104 in communication with a service or application 106 via the network 102.

According to some aspects of this disclosure, the user device 104 may include a computing device, a smart device, a mobile device, a laptop, a tablet, a set-top box, a display device, or any other device capable of communicating with an application 106, a database 126, a software platform, and/or another device. The user device 104 may include a communication module that facilitates and/or enables communication with the application 106, database 126, software platform, and/or any other device/component of the environment 100.

Environment 100 may include a testing component 120. The testing component 120 may include hardware and/or software to facilitate unified connectivity testing and validation.

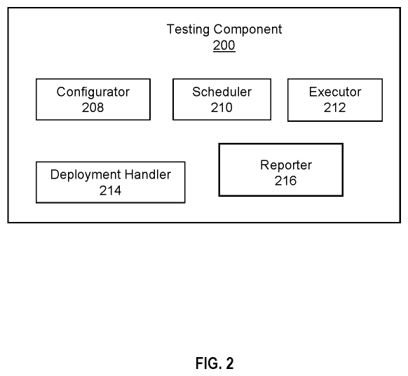

FIG. 2 illustrates a block diagram of an exemplary testing component 200 for unified connectivity testing and validation according to aspects of the present disclosure. As shown in FIG. 2, the testing component 200 includes a configurator 208, a scheduler 210, an executor 212, a deployment handler 214, and a reporter 216, and may represent an exemplary embodiment of testing component 200. The testing component 200 may include any hardware and/or software necessary to facilitate unified connectivity testing and validation.

According to some aspects of this disclosure, the configurator 208 may allow a user to input a request for a connectivity test and/or configure how a connectivity test will be performed. For example, the configurator 208 may allow the user to define metadata for running connectivity tests. The configuration may be based on user input.

The executor 212 may determine which type of connectivity test to perform, e.g., a service-to-service connectivity test, a point-to-point connectivity test, and/or another type of connectivity test. The service-to-service connectivity test may test connectivity between two services 106-1, 106-2 such as for a uniform resource locator (URL) while the point-to-point connectivity test may test connectivity between two infrastructure components/controls 118-1, 118-2. For example, the executor 212 may determine the type of connectivity test based on connection information from user input such as source information, whether a data packet going along a connection needs to pass through multiple controls such as multiple layer 7 forward proxies and/or virtual private network (vpn) connection(s), etc. When the packet needs to pass through different controls, the connection is a service-to-service connection. The scheduler 210 may schedule when to perform the connectivity test, e.g., after the executor determines which type of connectivity test to perform.

The executor 212 may initiate and/or execute the connectivity test based on the determination, e.g., by invoking existing connectivity testing mechanisms, based on a determination, schedule, and/or configuration by the configurator 208 and/or the scheduler 210. The deployment handler 214 may deploy components and/or changes to the components to the testing component 120. For example, the deployment handler 214 may gather or package functionality or tooling such as troubleshooting tools to generate an executable and build the executable as a container image. Alternatively or additionally, the deployment handler 214 may deploy the connectivity test through a representational state transfer (REST) application programming interface (API) and/or in a serverless framework.

The reporter 216 may report back to the user the testing result, such as a location of a connectivity issue or a next step to repair the connection.

Referring back to FIG. 1, environment 100 may include one or more applications 106-1, 106-2. According to some aspects of this disclosure, the application 106-1, 106-2 may provide a service including a content service, a communication service, a finance service, a monitoring service, a collaboration service, and/or another type of service. The application 106-1 may communicate with the application 106-2 and/or one or more controls 118-1, 118-2. The application 106-1, 106-2 may be deployed in a public network, private network, cloud provider managed services, same/different network segments, different network domains across regions for integration purposes, and/or in another way.

Environment 100 may include one or more controls 118-1, 118-2. According to some aspects of this disclosure, the controls 118-1, 118-2 may allow a user or administrator to manage and/or maintain infrastructure on which applications 106-1, 106-2 can run. Controls 118-1, 118-2 may provide foundation services to consumers for aspects of infrastructure, which is shared with other consumers. For example, the controls 118-1, 118-2 may provide security and/or availability guarantee for the applications 106-1, 106-2. The control 118-1, 118-2 may include a firewall, a load balancer, a router, an application firewall, an identity and access management (IAM) policy controller, a domain name system (DNS), an egress control, and/or another type of controls. The control 118-1 may communicate with control 118-2 and/or one or more applications 106-1, 106-2. The control 118-1, 118-2 may be deployed in a public or private network.

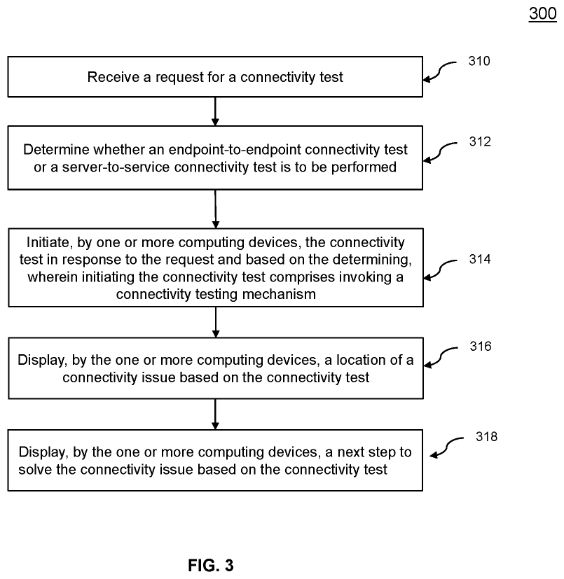

FIG. 3 shows a flowchart of an example method for unified connectivity testing and validation according to some aspects. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art.

Method 300 shall be described with reference to FIGS. 1 and 2. However, method 300 is not limited to the aspects of those figures.

In 310, the testing component 200, e.g., the configurator 208, receives a request for a connectivity test. According to some aspects of this disclosure, the connectivity test request may be input by a user via a user interface (UI) or the configurator 208, e.g., in a web view or in a window of the configurator 208.

In 312, the testing component 200 determines whether a point-to-point connectivity test or a service-to-service connectivity test is to be performed. For example, the scheduler 210 may determine the type of connectivity test based on user input such as source information, whether a data packet going along a connection needs to pass through multiple controls such as multiple layer 7 forward proxies and/or virtual private network (vpn) connection(s), etc. According to some aspects of this disclosure, the scheduler 210 may perform the determining. The test may be written and/or configured as a combination of other tests in a smart, autonomous way. The point-to-point connectivity test may include a specific connectivity health check for a data path between two endpoints while the service-to-service connectivity test may include a multi-stage, synthetic connectivity test for a service.

In embodiments, the point-to-point connectivity test may be configured towards a specific control and only test specific connectivity for that control. The tests may be fast and essentially emulate a health check kind of scenario, e.g., where the validation is limited to establishment of transmission control protocol (TCP) connection between the source and destination. For example, a control 118-1, 118-2 may program a layer 3 (L3) or layer 4 (L4) connectivity for a firewall component in a data path, and a point-to-point connectivity may be entailed. A point-to-point connectivity test such as a telnet connectivity test may be performed if the scheduler 210 determines that data packets are allowed to pass the firewalls. The same kind of point-to-point connectivity test may be applicable for another type controls such as DNS and egress gateway (GW).

A control owner may perform continuous deployment of control configurations, which could cause an outage due to a mis-configuration resulting in an existing connectivity loss. A post-deployment verification mechanism may be executed, e.g., by the executor 212, to validate that the connectivity posture before the test has not been reduced after the deployment, and then the new control configurations may be defined in the rollout configuration.

On the other hand, the service-to-service connectivity test may be applied in cases of service-to-service connectivity, for example, when a data packet needs to pass through different controls such as firewall(s), layer 7 forward proxies, virtual private network (vpn) connection(s) etc. The data packets may also need to be validated at a higher level of network stack such as transport layer security (TLS) and/or mutual TLS (mTLS).

The connectivity test may be performed from a container of a source service or in a way the source and/or destination could be impersonated. The test may examine the point-to-point connectivity through different controls. Instead of performing only a specific troubleshooting step, the connectivity test may run a decision tree which runs the tests in a fashion to return what the issue is with the connectivity. For example, the smart test may determine there is an L3 connectivity issue and/or the control 118-1 or 118-2 might not be configured correctly.

Thus, the service-to-service connectivity test may be a sophisticated, multi-stage, and/or synthetic connectivity test. The service-to-service connectivity test may be intelligent and/or have logic or algorithm such as a decision tree to invoke different future tests based on success or failure of a current one. The test may report not only where the problem exists but also guide a user through next steps to fix or remedy the issue.

The service connectivity test may emulate how a service connects to another service, e.g., by connecting to a service using hypertext transfer protocol secure (HTTPS) with mutual authentication using X.509 certificates.

In 314, the testing component 200 initiates the connectivity test in response to the request and based on the determining, wherein initiating the connectivity test comprises invoking a connectivity testing mechanism. According to some aspects of this disclosure, the executor 212 may perform the initiating.

For example, when it is determined the type of connectivity test is service-to-service, the initiating the connectivity test may comprise performing a decision tree test to determine the connectivity issue. The decision tree method may generate a next step to solve the connectivity determined based on the decision tree test.

The connectivity test may be developed, configured, executed, and/or deployed in various ways. A single source of code may be utilized to test and/or validate different types of connectivity. This way, duplication of code spreaded across multiple repositories and maintainability concerns may be reduced. The connectivity tests may be written in a way so they can be invoked individually or in combination. The connectivity tests may be flexible and programmed through an abstract interface, e.g., an abstraction that represents more than one interface. For example, functionality such as a discovery mechanism, connectivity testing/troubleshooting mechanism, decision tree test, and/or another tool for the connectivity test may be gathered or packaged to generate an executable to be built as a container image by the testing component 200 such as the deployment handler 214. A container may be a lightweight package of software including necessary elements to run in an environment. A container image may include components a container needs to run. The container image may be stored in a container registry such as an artifact registry and/or may run from a framework for integrated test (FIT) framework. The connectivity test may be deployed, e.g., by the testing component 200 or the deployment handler 214 through a representational state transfer (REST) application programming interface (API) and/or deployed in a serverless framework. Alternatively or additionally, the connectivity test may be added as a part in a container orchestration system such as in a Kubernetes system or framework.

According to some aspects of this disclosure, various interfaces may be utilized by the testing component 200 or configurator 208, e.g., to invoke a connectivity testing mechanism, for user input, etc. The interfaces may include a command line interface (CLI), scripts, standard UIs, configuration files, bots, etc.

The connectivity test may be configured to perform periodically and/or continuously to monitor connectivity or on demand. For the tests that need to be run in continuous fashion the system may need metadata and/or information such as the source, destination, nature of tests, port, protocol, and/or other information. The testing component 120 may utilize a discovery mechanism to automatically find the metadata. Traffic or data packets in a FD may go through an egress proxy on the way out and information such as URLs and status codes may be logged. An automation may be built to scrap the logs to find the above mentioned information from the logs and a map may be built on who is talking to who with success or failure information. The information may be placed in different ranges of success and failure rate, on which the results of the connectivity test may be based.

Alternatively or additionally, relevant information may be captured as part of infrastructure 118-1, 118-2, e.g., as part of bill of materials (BoM). The information may be parsed into intra FD communication and inter FD communication. The intra FD communication may include communication on non-overlapping internet protocol (IP) (i.e., private) space while the inter FD communication may include communication on overlapping IP (i.e., private or public) space.

Different parts of the BOM may be utilized. For example, intra FD communication information may be extracted from intra FD policies described in FD definitions or authorized client defined in service definitions. Inter FD communication may be extracted from outbound access part of service definition, configuration for cloud native regional connectivity control, and/or vpn configurations.

To achieve the connectivity tests, the testing component 200, e.g., the configurator 208, may allow the user to define metadata for running connectivity tests. Additionally or alternatively as discussed above, a framework may be utilized to conduct the connectivity test such as in a serverless or container based framework. The framework may be utilized for ad hoc/on-demand connectivity tests or continuous connectivity monitoring.

In the control owner's case, the framework may include a wrapper on top of the existing tooling to execute the tooling in a specific manner. A wrapper may be a program or codes configured to wrap around and/or call another program component. The framework may include An interface (e.g., configuration files/APIs) for input parameters. Input parameters may include a list of source and destination, a type of a test, a duration of the test, and/or retries. The framework may further include a recipe for the wrapper which can be customized with the input parameters and invoke the existing tooling.

A recipe may be specific to a control 118-1, 118-2. For example, for a specific control 118-1, 118-2 that enables the Layer 3/Layer 4 connectivity, the recipe may test the TCP/user datagram protocol (UDP) connectivity and not perform Layer 7 tests such as hypertext transfer protocol (HTTP) tests. The recipe may focus more on the lightness of the tests which cover broad strokes but across the breadth of the infrastructure. The recipe might be configured to run TCP connectivity tests for over 100 services deployed in a FD instance and run these tests in parallel for other FD instances.

In the service owner's case, an interface for user inputs may be provided by the configurator 208. User inputs may include destinations, type of tests, and/or frequency of tests. Information from the user inputs may be different than that of the control owner's case because the individual tests may perform multiple layers of control testing including, e.g., network segmentation control egress gw, cloud native regional connectivity control, etc. So a service-to-service connectivity test may validate the controls along its path for different layers of communication. The connectivity test may be performed utilizing impersonation, e.g., providing flexibility where the source and/or destination is out of the control of the testing component 120 or when a user need to log into a service to conduct the connectivity. For example, a service-to-service connectivity test may be performed from a service among a plurality of services on the source side, e.g., by replacing a target service with a service chosen from the plurality of services on the source side. According to some aspects of this disclosure, a FIT test container may be utilized as a source. Additionally or alternatively, the service-to-service connectivity test may be performed to a service among a plurality of services on the destination side, e.g., by replacing a target service with a service chosen from the plurality of services on the destination side. In 316, the testing component 200 displays a location of a connectivity issue based on the connectivity test. According to some aspects of this disclosure, the executor 212 may send an instruction to a display to display this location.

In 318, the testing component 200 displays a next step to solve the connectivity issue based on the connectivity test. According to some aspects of this disclosure, the executor 212 may send an instruction to a display the next step, e.g., to fix or remedy the connectivity issue similar to the abovementioned decision tree test case. According to some aspects of this disclosure, when the connectivity test fails and a connectivity issue is determined to exist, a plurality of parameters may be determined based on details of the connectivity test result. A second connectivity test may be performed based on the details to narrow down the issue.

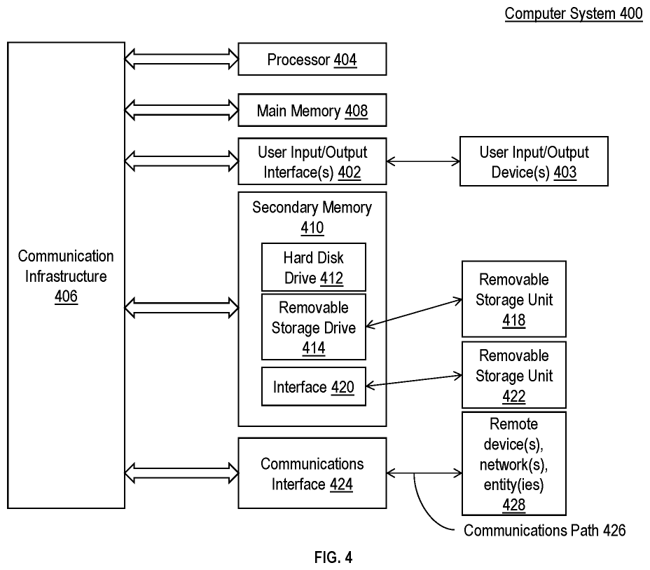

FIG. 4 is an example computer system useful for implementing various embodiments. Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof. According to some aspects of this disclosure, the user device 104 of FIG. 1 (and/or any other device/component described herein) may be implemented using the computer system 400. According to some aspects of this disclosure, the computer system 400 may be used to implement method 300 and/or any other methods and/or steps described herein.

Computer system 400 may include one or more processors (also called central processing units, or CPUs), such as a processor 404. Processor 404 may be connected to a communication infrastructure or bus 406.

Computer system 400 may also include user input/output device(s) 402, 403 such as monitors, keyboards, pointing devices, etc., which may communicate with communication infrastructure or bus 406 through user input/output device(s) 402, 403.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, a tape backup device, and/or any other storage device/drive.

Removable storage drive 414 may interact with a removable storage unit 418. The removable storage unit 418 may include a computer-usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to the removable storage unit 418.

Secondary memory 410 may include other means, devices, components, instrumentalities, and/or other approaches for allowing computer programs and/or other instructions and/or data to be accessed by computer system 400. Such means, devices, components, instrumentalities, and/or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smartphone, smartwatch or other wearables, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, and/or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

Additionally and/or alternatively, while this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

One or more parts of the above implementations may include software. Software is a general term whose meaning of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “an aspect,” “aspects,” “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for testing connectivity, comprising:
receiving, by one or more computing devices, a request for a connectivity test;
determining, by the one or more computing devices, whether a point-to-point connectivity test or a service-to-service connectivity test is to be performed;
initiating, by one or more computing devices, the connectivity test in response to the request and based on the determining, wherein initiating the connectivity test comprises invoking a connectivity testing mechanism;
displaying, by the one or more computing devices, a location of a connectivity issue based on the connectivity test; and
displaying, by the one or more computing devices, a next step to solve the connectivity issue based on the connectivity test.

2. The method of claim 1, wherein, in response to determining the type of connectivity test is service to service, the initiating the connectivity test comprises performing a decision tree test to determine the connectivity issue.

3. The method of claim 2, wherein the next step to solve the connectivity issue is determined based on the decision tree test.

4. The method of claim 2, further comprising performing, the connectivity test from a service among a plurality of services on the source side.

5. The method of claim 2, further comprising performing, the connectivity test to a service among a plurality of services on the destination side.

6. The method of claim 5, wherein when the connectivity test fails and a connectivity issue is determined to exist, a plurality of parameters are determined based on details of the connectivity test and a second connectivity test is performed to narrow down the issue.

7. The method of claim 1, wherein the connectivity test is performed periodically.

8. A non-transitory computer-readable medium having instructions stored thereon that, when executed by at least one computing device, causes the at least one computing device to perform operations comprising:
receiving a request for a connectivity test;
determining whether a point-to-point connectivity test or a service-to-service connectivity test is to be performed;
initiating the connectivity test in response to the request and based on the determining, wherein initiating the connectivity test comprises invoking a connectivity testing mechanism;
displaying a location of a connectivity issue based on the connectivity test; and
displaying a next step to solve the connectivity issue based on the connectivity test.

9. The non-transitory computer-readable medium of claim 8, wherein, in response to determining the type of connectivity test is service to service, the initiating the connectivity test comprises performing a decision tree test to determine the connectivity issue.

10. The non-transitory computer-readable medium of claim 9, wherein the next step to solve the connectivity issue is determined based on the decision tree test.

11. The non-transitory computer-readable medium of claim 9, further comprising performing, the connectivity test from a service among a plurality of services on the source side.

12. The non-transitory computer-readable medium of claim 9, further comprising performing, the connectivity test to a service among a plurality of services on the destination side.

13. The non-transitory computer-readable medium of claim 12, wherein when the connectivity test fails and a connectivity issue is determined to exist, a plurality of parameters are determined based on details of the connectivity test and a second connectivity test is performed to narrow down the issue.

14. The non-transitory computer-readable medium of claim 8, wherein the connectivity test is performed periodically.

15. A system comprising:
a memory; and
at least one processor coupled to the memory and configured to perform operations comprising:
receiving a request for a connectivity test;
determining whether a point-to-point connectivity test or a service-to-service connectivity test is to be performed;
initiating the connectivity test in response to the request and based on the determining, wherein initiating the connectivity test comprises invoking a connectivity testing mechanism;
displaying a location of a connectivity issue based on the connectivity test; and
displaying a next step to solve the connectivity issue based on the connectivity test.

16. The system of claim 15, wherein, in response to determining the type of connectivity test is service to service, the initiating the connectivity test comprises performing a decision tree test to determine the connectivity issue.

17. The system of claim 16, wherein the next step to solve the connectivity issue is determined based on the decision tree test.

18. The system of claim 16, further comprising performing, the connectivity test from a service among a plurality of services on the source side.

19. The system of claim 16, further comprising performing, the connectivity test to a service among a plurality of services on the destination side.

20. The system of claim 19, wherein when the connectivity test fails and a connectivity issue is determined to exist, a plurality of parameters are determined based on details of the connectivity test and a second connectivity test is performed to narrow down the issue.
